(19) United States
(12) Patent Application Publication
(10) Pub. No.: US 2025/0075297 A1
(43) Pub. Date: Mar. 6, 2025

(54) RARE-EARTH COBALT PERMANENT MAGNET, METHOD FOR MANUFACTURING RARE-EARTH COBALT PERMANENT MAGNET, AND DEVICE

(71) Applicant: TOKIN Corporation, Shiroishi-shi (JP)

(72) Inventors: Hiroaki MACHIDA, Shiroishi-shi (JP); Teruhiko FUJIWARA, Shiroishi-shi (JP)

(21) Appl. No.: 18/805,424

(22) Filed: Aug. 14, 2024

(30) Foreign Application Priority Data
Aug. 31, 2023 (JP) 2023-140900

(51) Int. Cl. C22C 30/00; B22F 3/16; B22F 3/24; B22F 9/04; H01F 1/055; H01F 41/02

(52) U.S. Cl. CPC C22C 30/00; B22F 3/16; B22F 3/24; B22F 9/04; H01F 1/0557; H01F 41/0266; B22F 2003/248; B22F 2009/043; B22F 2201/10; B22F 2201/20; B22F 2301/00; B22F 2304/10; B22F 2998/10; B22F 2999/00; C22C 2202/02

(57) ABSTRACT

A rare-earth cobalt permanent magnet according to an aspect of the present disclosure consists of a sintered compact having a composition consisting of R: 24 to 27 wt % (R is a total of rare-earth elements), Fe: 23 to 27 wt %, Cu: 4.0 to 5.0 wt %, Zr: 1.5 to 2.5 wt %, Mn: 0.1 to 2.5 wt %, and a remainder consisting of Co and unavoidable impurities, in which: the rare-earth cobalt permanent magnet contains a plurality of crystal grains and grain boundary phases; an average concentration of Mn in the grain boundary phases is 0.5 to 1.5 times higher than an average concentration of Mn in the crystal grains; the crystal grains have a 2-17 phase having a Th₂Zn₁₇-type structure and a 1-5 phase having an RCo₅-type structure; and an average concentration of Mn in the 1-5 phase is 0.4 to 1.5 times higher than an average concentration of Mn in the 2-17 phase.

### INCORPORATION BY REFERENCE

This application is based upon and claims the benefit of priority from Japanese patent application No. 2023-140900, filed on Aug. 31, 2023, the disclosure of which is incorporated herein in its entirety by reference.

### BACKGROUND

The present disclosure relates to a rare-earth cobalt permanent magnet, a method for manufacturing a rare-earth cobalt permanent magnet, and a device.

As a type of permanent magnet, a rare-earth cobalt permanent magnet such as a samarium-cobalt magnet has been known. Regarding rare-earth cobalt permanent magnets, studies regarding those that contain Fe, Cu, Zr or the like have been conducted from various aspects, for example, for improving their magnetic properties.

For example, Japanese Unexamined Patent Application Publication No. 2017-168827 discloses a permanent magnet that contains specific respective amounts of rare-earth elements Fe, Cu, Co, Zr, Ti and Hf, and has a structure containing crystal grains consisting of a main phase containing a Th₂Zn₁₇-type crystalline phase, and crystal grain boundaries between the crystal grains, in which the average grain size of the crystal grains is 50 to 100 μm.

International Patent Publication No. WO2015/140829 discloses a specific permanent magnet containing specific respective amounts of rare-earth elements Fe, Cu, Co, Zr, Ti and Hf, and has a cell phase containing a Th₂Zn₁₇-type crystalline phase and a Cu-rich phase having a Cu concentration higher than that of the cell phase, in which the average diameter of the cell phase is 220 nm or smaller.

Further, Japanese Unexamined Patent Application Publication No. 2020-188140 discloses a rare-earth cobalt permanent magnet containing specific respective amounts of rare-earth elements R, Fe, Cu, Co and Zr, and has cell walls containing a Th₂Zn₁₇-type crystalline phase and a crystalline phase having an RCo₅-type structure surrounding the cell phase, in which the concentration of the rare-earth elements in the cell walls is at least 25 at % higher than that of the rare-earth elements in the cell phase.

### SUMMARY

An object of the present disclosure is to provide a rare-earth cobalt permanent magnet having excellent magnetic properties, especially an excellent coercive force and excellent squareness, and to provide a method for manufacturing such a rare-earth cobalt permanent magnet and a device.

A rare-earth cobalt permanent magnet according to an aspect of the present disclosure consists of a sintered compact having a composition consisting of R: 24 to 27 wt % (R is a sum total of rare-earth elements including at least Sm), Fe: 23 to 27 wt %, Cu: 4.0 to 5.0 wt %, Zr: 1.5 to 2.5 wt %, Mn: 0.1 to 2.5 wt %, and a remainder consisting of Co and unavoidable impurities, in which the rare-earth cobalt permanent magnet contains a plurality of crystal grains and grain boundary phases, and an average concentration of Mn in the grain boundary phases is 0.5 to 1.5 times higher than an average concentration of Mn in the crystal grains, and the crystal grains have a 2-17 phase having a Th₂Zn₁₇-type structure and a 1-5 phase having an RCo₅-type structure, and an average concentration of Mn in the 1-5 phase is 0.4 to 1.5 times higher than an average concentration of Mn in the 2-17 phase.

A device according to an aspect of the present disclosure is a device including the above-described rare-earth cobalt permanent magnet.

A method for manufacturing a rare-earth cobalt permanent magnet according to an aspect of the present disclosure includes: a step (I) of preparing an ingot containing raw materials so that, after sintering, the ingot has a composition consisting of R: 24 to 27 wt % (R is a sum total of rare-earth elements including at least Sm), Fe: 23 to 27 wt %, Cu: 4.0 to 5.0 wt %, Zr: 1.5 to 2.5 wt %, Mn: 0.1 to 2.5 wt %, and a remainder consisting of Co and unavoidable impurities; a pulverizing step (II) of pulverizing the ingot into a powder; a pressure-molding step (III) of molding the powder into a molded body; a sintering step (IV) of heating the molded body and thereby forming a sintered compact; a solution-treatment step (V) of heating the sintered compact and thereby performing a solution treatment; and a rapid cooling step (VI) of rapidly cooling the sintered compact after the solution-treatment step (V), and an aging process step (VII) of forming a 2-17 phase having a Th₂Zn₁₇-type structure and a 1-5 phase having an RCo₅-type structure. The step (I) of preparing the ingot includes: a first ingot heat treatment step of treating a mixture of the raw materials at a first ingot heat treatment temperature; and a second ingot heat treatment step of treating the mixture at a second ingot heat treatment temperature after the first ingot heat treatment step. When a sintering temperature of the molded body is represented by S1 and a temperature of the solution treatment is represented by S2, the first ingot heat treatment temperature T1 satisfies a relation S1−50≤T1≤S1 (however, when a temperature difference between S1 and S2 is equal to or smaller than 50° C., the first ingot heat treatment temperature T1 satisfies a relation S2<T1≤S1), and the second ingot heat treatment temperature T2 satisfies a relation S2−30≤T2≤S2.

According to the present disclosure, it is possible to provide a rare-earth cobalt permanent magnet having excellent magnetic properties, especially an excellent coercive force and excellent squareness, and to provide a method for manufacturing such a rare-earth cobalt permanent magnet and a device.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic diagram showing an example of a cross section of a rare-earth cobalt permanent magnet according to an embodiment;

FIG. 2 is an enlarged schematic diagram of a part A (a part of crystal grains) shown in FIG. 1;

FIG. 3 is an electron micrograph of a rare-earth cobalt permanent magnet according to an embodiment;

FIG. 4 is a graph showing result of an analysis of a composition of a rare-earth cobalt permanent magnet according to an embodiment;

FIG. 5 is an electron micrograph of a rare-earth cobalt permanent magnet according to an embodiment; and

FIG. 6 is a graph showing result of an analysis of a composition of a rare-earth cobalt permanent magnet according to an embodiment.

### DESCRIPTION OF EMBODIMENTS

Embodiments according to the present disclosure will be described hereinafter.

Note that a numerical range such as “n-m” or “n to m” (i.e., “from n to m”) includes the lower and upper limit values, unless otherwise specified.

### <Rare-Earth Cobalt Permanent Magnet>

A rare-earth cobalt permanent magnet according to this embodiment (hereinafter also referred to as the permanent magnet) consists of a sintered compact having a composition consisting of R: 24 to 27 wt % (R is a sum total of rare-earth elements including at least Sm), Fe: 23 to 27 wt %, Cu: 4.0 to 5.0 wt %, Zr: 1.5 to 2.5 wt %, Mn: 0.1 to 2.5 wt %, and a remainder consisting of Co and unavoidable impurities, in which: the rare-earth cobalt permanent magnet contains a plurality of crystal grains and grain boundary phases; an average concentration of Mn in the grain boundary phases is 0.5 to 1.5 times higher than an average concentration of Mn in the crystal grains; the crystal grains have a 2-17 phase having a Th₂Zn₁₇-type structure and a 1-5 phase having an RCo₅-type structure; and an average concentration of Mn in the 1-5 phase is 0.4 to 1.5 times higher than an average concentration of Mn in the 2-17 phase.

In this embodiment, the term “rare-earth element R” is a generic term for Sc, Y, and lanthanoids (elements having atomic numbers 57 to 71), and includes at least Sm as the rare-earth element R. As the rare-earth element R, only Sm may be used, or a combination of Sm and at least one type of other rare-earth elements may be used. As the other rare-earth elements, Pr, Nd, Ce and La are preferred in view of the magnetic properties. Further, in view of the magnetic properties, the content of Sm is preferably 80 wt % or larger, more preferably 90 wt % or larger, and still more preferably 95 wt % or larger based on the total amount of the rare-earth elements R. The permanent magnet contains 24 to 27 wt %, preferably 24 to 26 wt %, of a rare-earth element(s) R. By having the permanent magnet contain the rare-earth elements in the aforementioned ratio, it is possible to obtain a permanent magnet having high magnetic anisotropy and a high coercive force.

The permanent magnet contains 23 to 27 wt %, preferably 23 to 26.5 wt %, of Fe. The saturation magnetization is improved by containing 23 wt % of Fe or larger. Further, by adjusting the content of Fe to 27 wt % or smaller, the permanent magnet has a high coercive force.

The permanent magnet contains 4.0 to 5.0, preferably 4.0 to 4.7 wt %, of Cu. By containing 4.0 wt % of Cu or larger, the permanent magnet has a high coercive force. Further, by adjusting the content of Cu to 5.0 wt % or smaller, the deterioration of the magnetization is suppressed.

The permanent magnet contains 0.1 to 2.5 wt %, preferably 0.15 to 1.5 wt %, of Mn. By containing 0.1 wt % of Mn or larger, the concentration of Cu in the grain boundary phases can be increased. Further, by having the permanent magnet contain Mn in the above-described range, crystal structures containing crystal grains having relatively large and uniform grain sizes can be easily obtained, so that the squareness ratio is improved. On the other hand, when the content of Mn exceeds 2.5 wt %, the grain sizes tend to become smaller instead of becoming larger.

It is presumed that, by containing 0.1 wt % of Mn or larger, the melting point is lowered, so that the liquid phase appears more during the sintering and a distribution of concentrations of Cu and the like is formed. Further, it is presumed that since the liquid phase appears a lot, the grain size of crystal grains increases. Further, it is presumed that Mn also contributes to the non-magnetization of the grain boundary phase, so that the occurrences of reverse magnetic domains in the grain boundary phase are suppressed.

The permanent magnet contains 1.5 to 2.5 wt %, preferably 1.9 to 2.3 wt %, of Zr. By containing 1.5 to 2.5% of Zr, it is possible to obtain a permanent magnet having a high maximum energy product (BH)m, which is the maximum magnetostatic energy that the magnet can hold.

Further, the remainder of the permanent magnet consists of Co and unavoidable impurities. By having the permanent magnet contain Co, the thermal stability of the permanent magnet is improved. However, when the content of Co is too large, the content of Fe is relatively reduced. The unavoidable impurities are elements that are unavoidably mixed in the permanent magnet from the raw material or during the manufacturing process. Examples of unavoidable impurities include, but are not limited to, C, N, P, S, Al, Ti, Cr, Ni, Hf, Sn and W. In the permanent magnet, the total ratio of unavoidable impurities is preferably 5 wt % or lower, more preferably 1 wt % or lower, still more preferably 0.1 wt % or lower based on the total amount of the permanent magnet. The content ratio of each of the elements contained in a local area (i.e., in a small area) of the permanent magnet can be measured, for example, by using energy dispersive X-ray spectroscopy (EDX: Energy dispersive X-ray spectrometry).

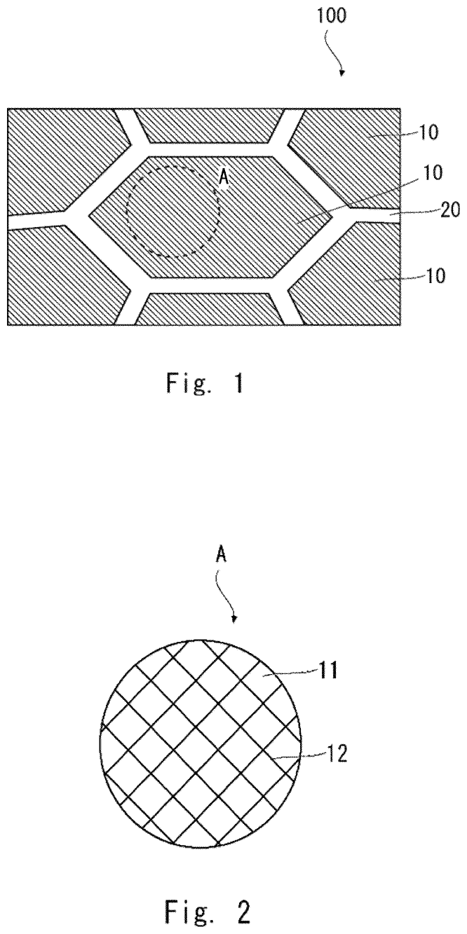

A metallographic structure of a permanent magnet according to the present disclosure will be described with reference to FIGS. 1 and 2. FIG. 1 is a schematic diagram showing an example of a cross section of a permanent magnet according to this embodiment, and FIG. 2 is an enlarged schematic diagram of a part A (a part of a crystal grain 10) shown in FIG. 1. As shown in the example shown in FIG. 1, the rare-earth cobalt permanent magnet 100 according to this embodiment contains a plurality of crystal grains 10 and grain boundary phases 20 present between the crystal grains 10. Further, as shown in the example shown in FIG. 2, each crystal grain 10 has the following structure (hereinafter also referred to as a cell structure), i.e., has a phase 11 having a Th₂Zn₁₇-type structure (hereinafter also referred to as the 2-17 phase 11) and a phase 12 having an RCo₅-type structure (hereinafter also referred to as the 1-5 phase 12), in which the 2-17 phase is the main phase (having a volume ratio of 50% or higher). Note that the crystal grain 10 may further have a crystal phase having a TbCu₇-type structure (hereinafter also referred to as the 1-7 phase) (not shown).

The phase 11 having the Th₂Zn₁₇-type structure is a crystal structure having an R-3m-type space group. In the permanent magnet, in general, the Th part is occupied by a rare-earth element and Zr, and the Zn part is occupied by Co, Cu, Fe and Zr. Further, in the phase 12 having the RCo₅-type structure, in general, the R part is occupied by a rare-earth element and Zr, and the Co part is occupied by Co, Cu and Fe. Further, in the crystal phase having the TbCu₇-type structure, in general, the Tb part is occupied by a rare-earth element and Zr, and the Cu part is occupied by Co, Cu and Fe. The crystal structure can be determined by an X-ray diffraction method.

As described above, in the permanent magnet according to the present disclosure, the average concentration of Mn in the grain boundary phases 20 is 0.5 to 1.5 times higher than the average concentration of Mn in the crystal grains 10. Further, the average concentration of Mn in the 1-5 phase 12 is 0.4 to 1.5 times higher than the average concentration of Mn in the 2-17 phase 11. Therefore, it is possible to obtain a rare-earth cobalt permanent magnet having excellent magnetic properties, especially an excellent coercive force and excellent squareness.

In the permanent magnet, the average concentration of Mn in the grain boundary phases 20 is preferably 0.8 to 1.2 times higher than the average concentration of Mn in the crystal grains 10. Further, the average concentrations of Cu and Zr in the grain boundary phase 20 may be at least two times higher, and preferably at least four times higher, than the average concentrations of Cu and Zr in the crystal grains 10. Further, the average concentration of Mn in the 1-5 phase 12 is preferably 0.8 to 1.0 times higher than the average concentration of Mn in the 2-17 phase 11. In this embodiment, by adjusting various values so as to fall within their respective ranges, it is possible to obtain a rare-earth cobalt permanent magnet having more excellent magnetic properties.

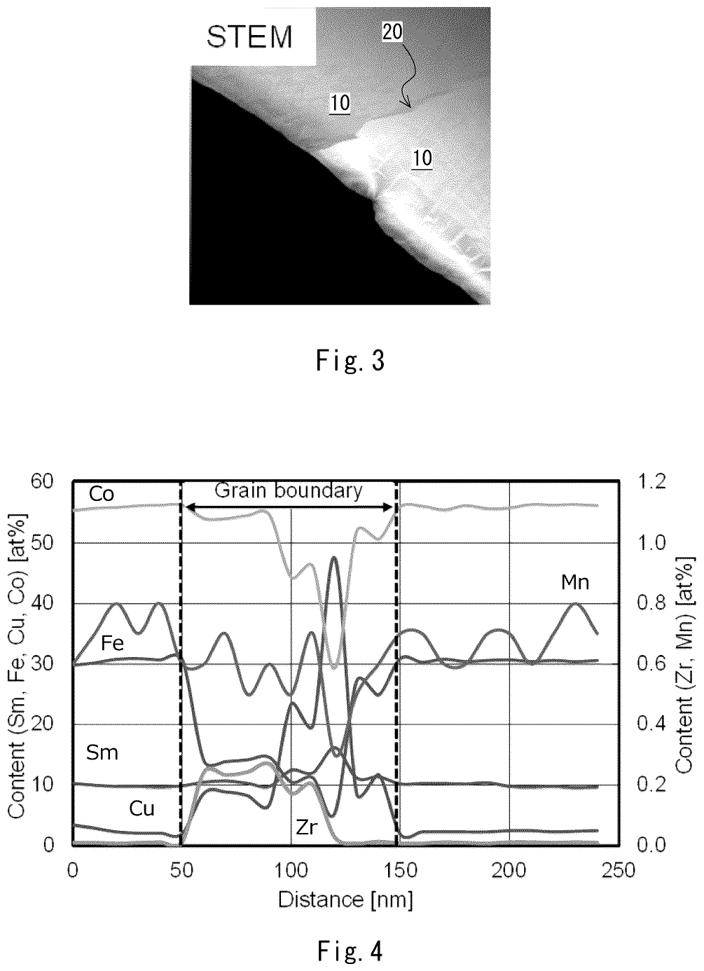

FIG. 3 is an electron micrograph of a rare-earth cobalt permanent magnet according to this embodiment, and shows crystal grains 10 and a grain boundary phase 20. FIG. 4 is a graph showing a result of an analysis of the composition of the rare-earth cobalt permanent magnet according to this embodiment, and is a graph showing a result of an analysis of a composition near the crystal grain 10 and the grain boundary phase 20. That is, the graph shown in FIG. 4 is a result of an analysis of a composition in an area that starts from a crystal grain 10, passes through a grain boundary phase 20, and ends at another crystal grain 10.

As shown in the electron micrograph shown in FIG. 3, a grain boundary phase 20 exists between crystal grains 10. Further, as shown in the result of the analysis of the composition shown in FIG. 4, the composition of various elements in the grain boundary phase 20 varies more widely compared with the composition of various elements in the crystal grains 10. Specifically, the amounts of Fe and Co decrease and the amounts of Cu and Zr increase in the grain boundary phase 20 compared with those in the crystal grains 10. Further, in this embodiment, the average concentrations of Cu and Zr in the grain boundary phases 20 are preferably at least two times higher, more preferably at least four times higher, than the average concentrations of Cu and Zr in the crystal grains 10. Further, the average concentration of Mn in the grain boundary phases 20 is preferably 0.5 to 1.5 times higher, more preferably 0.8 to 1.2 times higher, than the average concentration of Mn in the crystal grains 10. That is, in this embodiment, Mn is uniformly dispersed in the crystal grains 10 and the grain boundary phases 20 compared with Cu and Zr.

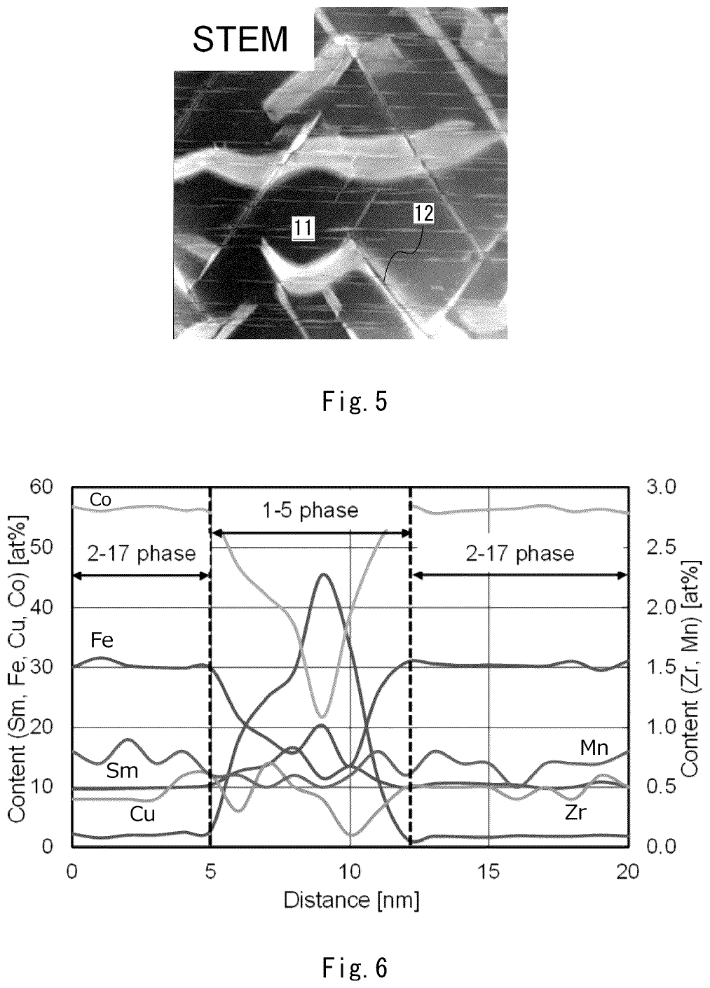

FIG. 5 is an electron micrograph of a rare-earth cobalt permanent magnet according to this embodiment, and shows a 2-17 phase 11 and a 1-5 phase 12 in a crystal grain. FIG. 6 is a graph showing a result of an analysis of the composition of the rare-earth cobalt permanent magnet according to this embodiment, and is a graph showing a result of an analysis of a composition of the 2-17 phase 11 and the 1-5 phase 12. That is, the graph shown in FIG. 6 is a result of an analysis of a composition in an area that starts from a 2-17 phase 11, passes through a 1-5 phase 12, and ends at another 2-17 phase 11.

As shown in the electron micrograph shown in FIG. 5, there are a 2-17 phase 11 and a 1-5 phase 12 in a crystal grain. Further, as shown in the result of the analysis of the composition shown in FIG. 6, the composition of various elements in the 1-5 phase 12 varies more widely compared with the composition of various elements in the 2-17 phase 11. Specifically, the amounts of Fe, Co and Zr decrease and the amounts of Cu and Sm increase in the 1-5 phase 12 compared with those in the 2-17 phase 11. Further, in this embodiment, the average concentration of Mn in the 1-5 phase 12 is preferably 0.4 to 1.5 times higher, more preferably 0.8 to 1.0 times higher, than the average concentration of Mn in the 2-17 phase 11. That is, in this embodiment, Mn is uniformly dispersed in the crystal grain compared with Cu and Zr. That is, Mn is uniformly dispersed in the 2-17 phase 11 and the 1-5 phase 12 compared with Cu and Zr.

In this embodiment, the “average concentration” of each element is an arithmetic average concentration at a point where an analysis of a respective phase is carried out.

Note that regarding the electron micrographs and the results of analyses of compositions shown in FIGS. 3 to 6, measurement can be carried out by the following method. Firstly, a sample is physically polished with water-resistant polishing paper or the like. After that, the surface is processed so that no irregularities are formed thereon by using a focused ion beam (FIB: Focused Ion Beam) or ion milling. For a sample processed as described above, a target point is observed by using a transmission electron microscope (TEM: Transmission Electron Microscope). In this process, the magnification is 3,000 to 5,000 for the grain boundary phase and 10,000 to 30,000 for the cell structure in the crystal grain. Further, the composition is directly analyzed at the observation point by using energy dispersive X-ray spectroscopy (EDX: Energy Dispersive X-ray Spectroscopy). The composition may be preferably analyzed at 5 to 20 nm in the grain boundary phase, and analyzed at 0.5 to 2.0 nm in the cell structure.

The density of a sintered compact for a permanent magnet according to the present disclosure is preferably 8.20 to 8.45 g/cm³ and more preferably 8.25 to 8.40 g/cm³. By adjusting the density of the sintered compact so as to fall within the aforementioned range, in particular, the residual magnetic flux density (Br) and the squareness ratio can be improved.

One of features of the permanent magnet according to the present disclosure is that its structure is homogenized by heat treatment such as the sintering/solution treatment and the subsequent rapid cooling, and the characteristics of the permanent magnet are developed by further performing aging.

The residual magnetic flux density (Br) of the permanent magnet according to the present disclosure is 11.8 kG or higher, preferably 12.0 kG or higher. Further, the coercive force (Hcj) is 20 kOe or higher, preferably 22 kOe or higher. Further, the maximum energy product (BH)m is 260 kJ/m³ or higher, preferably 265 kJ/m³ or higher. Note that the maximum energy product (BH)m is maximum magnetostatic energy that the magnetic material can hold, and represents the maximum value of the product of the magnetic flux density B and the magnetic field H on a B-H demagnetization curve in the second quadrant (demagnetization curve) of the magnetization curve (B-H curve).

A squareness ratio, which is represented by a ratio (Hk/Hcj) of the magnetic field (Hk) to the coercive force (Hcj), of the permanent magnet is 65% or higher, preferably 70% or higher. Note that regarding the magnetic field (Hk), a magnetic field at 90% magnetization of the residual magnetization is represented by Hk.

It is presumed that in the permanent magnet according to the present disclosure, the coercive force is developed because the domain wall is pinned between the two phases, i.e., the 2-17 phase and the 1-5 phase when the domain wall moves. Further, since Fe and Cu are concentrated into the 2-17 phase and the 1-5 phase, respectively, at the time of the separation into the two phases, the squareness ratio is improved and the maximum energy product (BH)m is increased. Further, the more the composition ratio between the 2-17 phase and the 1-5 phase is constant throughout the sample, the more excellent the obtained excellent magnetic properties become.

To measure magnetic properties, the sample is first processed into a predetermined shape. In the case where a DC (Direct Current) B-H tracer is used, the magnet is magnetized by applying a magnetic field about three to four times higher than the predicted Hcj, and then measurement is carried out according to the usage method of the apparatus. In the case where a pulse-type B-H tracer is used, the magnetization is unnecessary.

### <Method for Manufacturing Rare-Earth Cobalt Permanent Magnet>

Next, a method for manufacturing a rare-earth cobalt permanent magnet according to an embodiment will be described.

A method for manufacturing a permanent magnet according to an aspect of the present disclosure includes: a step (I) of preparing an ingot containing raw materials so that, after sintering, the ingot has a composition consisting of R: 24 to 27 wt % (R is a sum total of rare-earth elements including at least Sm), Fe: 23 to 27 wt %, Cu: 4.0 to 5.0 wt %, Zr: 1.5 to 2.5 wt %, Mn: 0.1 to 2.5 wt %, and a remainder consisting of Co and unavoidable impurities; a pulverizing step (II) of pulverizing the ingot into a powder; a pressure-molding step (III) of molding the powder into a molded body; a sintering step (IV) of heating the molded body and thereby forming a sintered compact; a solution-treatment step (V) of heating the sintered compact and thereby performing a solution treatment; and a rapid cooling step (VI) of rapidly cooling the sintered compact after the solution-treatment step (V), and an aging process step (VII) of forming a 2-17 phase having a Th₂Zn₁₇-type structure and a 1-5 phase having an RCo₅-type structure. The step (I) of preparing the ingot includes: a first ingot heat treatment step of treating mixture of the raw materials at a first ingot heat treatment temperature; and a second ingot heat treatment step of treating the mixture at a second ingot heat treatment temperature after the first ingot heat treatment step. When a sintering temperature of the molded body is represented by S1 and a temperature of the solution treatment is represented by S2, the first ingot heat treatment temperature T1 satisfies a relation S1−50≤T1≤S1 (however, when a temperature difference between S1 and S2 is equal to or smaller than 50° C., the first ingot heat treatment temperature T1 satisfies a relation S2<T1≤S1), and the second ingot heat treatment temperature T2 satisfies a relation S2−30≤T2≤S2.

The method for manufacturing a permanent magnet according to the present disclosure will be described hereinafter in detail.

In the step (I) of preparing an ingot containing raw materials, as the raw materials, Sm is used as a base element. Further, rare-earth elements such as Nd, Pr and Ce; Fe, Cu and Co; and a base alloy such as FeZr or CuZr are used. Note that it is preferred to select a base alloy having a composition having a low eutectic temperature because it makes easy to homogenize the composition of the alloy ingot. For example, FeZr or CuZr is preferred. In the case of FeZr, a weight ratio of about 80% of Fe and about 20% of Zr is suitable for this embodiment, and in the case of CuZr, a weight ratio of about 50% of Cu and about 50% of Zr is suitable for this embodiment. The alloy ingot is obtained by mixing these raw materials so that a predetermined composition is obtained, putting the mixture in a crucible such as an alumina crucible, dissolving the mixture in a vacuum of 1×10⁻² torr or lower or in an inert gas atmosphere by a high-frequency melting furnace, and casting the molten metal into a mold.

In consideration of the manufacturing cost, it is desirable if the obtained alloy is used as it is. However, in this embodiment, heat treatment is performed in order to make the structure more homogeneous and thereby to improve the magnetic properties. Specifically, in order to eliminate and homogenize the phases that have been formed during the casting, a first ingot heat treatment step, which is performed at a first ingot heat treatment temperature, and a second ingot heat treatment step, which is performed at a second ingot heat treatment temperature, are carried out.

In the first ingot heat treatment step, the first ingot heat treatment temperature is preferably lower than the sintering temperature and 50° C. higher than the solution-treatment temperature in order to suppress the evaporation of Sm. However, when the difference between the sintering temperature and the solution-treatment temperature is equal to or smaller than 50° C., the first ingot heat treatment temperature is preferably lower than the sintering temperature and higher than the solution-treatment temperature. Specifically, when the sintering temperature of the molded body is represented by S1 and the temperature of the solution treatment (solution-treatment temperature) is represented by S2, the first ingot heat treatment temperature T1 is preferably set so as to satisfy a relation S1−50≤T1≤S1 (however, when the temperature difference between S1 and S2 is equal to or smaller than 50° C., the first ingot heat treatment temperature T1 satisfies a relation S2<T1≤S1). Further, in this embodiment, the first ingot heat treatment temperature T1 is more preferably set so as to satisfy S1−30≤T1≤S1 (however, when the temperature difference between S1 and S2 is equal to or smaller than 30° C., the first ingot heat treatment temperature T1 satisfies the relation S2<T1≤S1). A heat treatment time of the first ingot heat treatment step is preferably 0.5 to 3 hours and more preferably 1 to 2 hours. By setting the heat treatment temperature and the heat treatment time so as to fall within the aforementioned ranges, it is possible to eliminate the dendrite phase and other undesired phases while suppressing the evaporation of Sm.

Further, in the second ingot heat treatment step, in order to improve the homogenization, the second ingot heat treatment temperature is preferably equal to or lower than the solution-treatment temperature and higher than a temperature 30 degrees lower than the solution-treatment temperature. Specifically, the second ingot heat treatment temperature T2 is preferably set so as to satisfy a relation S2−30≤T2≤S2. Further, in this embodiment, more preferably, the second ingot heat treatment temperature T2 is set so as to satisfy a relation S2−20≤T2≤S2. A heat treatment time of the second ingot heat treatment step is preferably 1 to 10 hours and more preferably 3 to 8 hours. By setting the heat treatment time so as to fall within the aforementioned range, it is possible to homogenize the structure while suppressing the evaporation of Sm.

When the temperature is changed from the first ingot heat treatment temperature T1 to the second ingot heat treatment temperature T2, the temperature is preferably lowered at a rate of 0.1 to 20° C./min and more preferably at a rate of 1 to 10° C./min in order to suppress the evaporation of Sm and improve the homogenization. Note that in this embodiment, the ingot heat treatment step is not limited to two steps. That is, the ingot heat treatment step may be divided into three or more steps. Further, instead of casting the molten metal into a mold, a method called strip casting in which flake-like pieces of an alloy having a thickness of about 1 mm is obtained by dropping molten metal onto a copper roll may be used.

Next, the ingot prepared as described above is pulverized into a powder (Pulverizing Step (II)). Firstly, a powder having an average size of about 100 to 500 μm is obtained by coarsely pulverizing the ingot. Then, a powder having an average size of about 1 μm to 10 μm is obtained by finely pulverizing the coarsely-pulverized powder by a ball mill, a jet mill, or the like. By obtaining a powder having such an average particle size, it is possible to reduce the sintering time of the sintering step (which will be described later), and to manufacture a homogeneous permanent magnet. Further, in this embodiment, in order to improve the sintering property, the finely-pulverized powder preferably has the following distribution of particle sizes, i.e., D10, which is a particle size value of 10% or less of the whole powder, is smaller than 4 μm; a median diameter D50 (a particle size value of 50% or less of the whole powder) is 5 to 8 μm; and D90, which is a particle size value of 90% or less of the whole powder, is smaller than 16 μm. Further, more preferably, the finely-pulverized powder preferably has such the following distribution of particle sizes, i.e., D10 is smaller than 3 μm; D50 is 5 to 7 μm; and D90 is smaller than 15 μm. By adopting the above-described distribution of particle sizes, it is possible to obtain a sintered compact having a density of 8.20 g/cm³ or higher.

Next, a molded body is manufactured by pressure-molding the powder obtained as described above (Pressure-Molding Step (III)). In this embodiment, the obtained powder is preferably pressure-molded in a constant magnetic field in order to align the orientation of crystals of the powder and thereby to improve the magnetic properties thereof. There is no particular restriction on the relation between the direction of the magnetic field and the pressing direction, and they may be selected as appropriate according to the shape and the like of the product. For example, when a ring magnet or a thin plate-like magnet is manufactured, it is possible to use parallel magnetic-field pressing in which a magnetic field is applied in a direction parallel to the pressing direction. On the other hand, in order to achieve excellent magnetic properties, it is preferable to use right-angle magnetic-field pressing in which a magnetic field is applied at a right angle with respect to the pressing direction.

The magnitude of the magnetic field is not limited to any particular value, and the magnetic field may be, for example, a magnetic field of 15 kOe or smaller, or a magnetic field of 15 kOe or larger depending on the use or the like of the product. However, in order to achieve excellent magnetic properties, it is preferred to perform the pressure-molding in a magnetic field of 15 kOe or larger. Further, the pressure in the pressure molding may be adjusted as appropriate according to the size, the shape, and the like of the product. As an example, the pressure may be 0.5 to 2.0 ton/cm².

Next, a sintered compact is obtained by heating the molded body obtained as described above (Sintering Step (IV)). In this embodiment, the conditions for the sintering can be arbitrarily determined as long as the obtained sintered compact is sufficiently densified. For example, known conditions may be used. In order to densify the sintered compact, the sintering temperature is preferably 1,170 to 1,215° C., and more preferably 1,180 to 1,210° C. By adjusting the temperature to 1,215° C. or lower, the rare-earth elements, particularly Sm, are prevented from evaporating, and hence a permanent magnet having excellent magnetic properties can be manufactured. Further, in this embodiment, since the melting point tends to decrease because Mn is contained, the sintering can be sufficiently performed at 1,215° C. or lower.

Regarding the temperature-increasing conditions during the sintering step, in order to remove the adsorptive gas contained in the molded body, it is preferable to start vacuuming at a room temperature and increase the temperature at a rate of 1 to 10° C./min. In the temperature-increasing process, a hydrogen atmosphere may be used instead of performing the vacuuming. Even in this case, it is preferable to switch the hydrogen atmosphere to the vacuum atmosphere in a temperature range of 1,150° C. or lower. The sintering time is preferably 20 to 210 minutes, and more preferably 30 to 150 minutes in order to sufficiently densify the sintered compact while preventing Sm from evaporating. Further, in order to prevent the oxidation, the above-described sintering step is preferably performed in a vacuum of 1,000 Pa or lower or in an inert-gas atmosphere. Further, in order to increase the density of the sintered compact, more preferably, the sintering step is performed in a vacuum of 100 Pa or lower.

Next, a solution treatment is performed by heating the sintered compact (Solution Treatment Step (V)). The solution treatment is a step for forming a 1-7 phase (a TbCu₇-type structure), which is a precursor for separation into a 2-17 phase and a 1-5 phase. In view of the production process, the solution treatment is performed in a continuous manner without cooling the sintered compact to a room temperature after the sintering. Note that when the temperature is changed from the sintering temperature to the solution-treatment temperature, the temperature is preferably lowered at a rate of 0.1 to 10° C./min and more preferable at a rate of 0.2 to 2.5° C./min in order to suppress the evaporation of Sm and improve the homogenization. The solution treatment is carried out at a temperature of 1,110 to 1165° C. in a vacuum of 1,000 Pa or lower or in an inert atmosphere. Since the optimum solution-treatment temperature changes depending on the composition, the solution treatment is preferably performed at a temperature suitable for the composition. If the solution-treatment temperature is too high, the homogenization cannot be carried out because the liquid phase remains, and if it is too low, the homogenization requires a long time. Therefore, the solution treatment is preferably performed at 1,120 to 1,160° C. Further, the solution-treatment time is preferably 5 to 150 hours and more preferably 10 to 100 hours. If the solution-treatment time is too short, the homogenization into the 1-7 phase becomes insufficient, and if the solution-treatment time is too long, Sm evaporates and hence excellent magnetic properties cannot be obtained. Therefore, the solution-treatment time is preferably in the aforementioned range.

Next, the sintered compact is rapidly cooled after the solution treatment (Rapid Cooling Step (VI)). The rapid cooling is a process to maintain the 1-7 phase obtained in the solution treatment, and if the rapid cooling is not sufficient, the structure changes during the cooling. In particular, a temperature range that is essential to make the rapid cooling effective is a range from the solution-treatment temperature to 600° C. In order to maintain the 1-7 phase, it is necessary to perform the rapid cooling at a rate of 60° C./min or higher in the aforementioned range, and is preferred to perform the rapid cooling at a rate of 80° C./min or higher.

Next, the 2-17 phase and the 1-5 phase are formed by performing an aging process for the molded body, which has been subjected to the rapid cooling step (Aging Process Step (VII)). Although the aging temperature is not limited to any particular temperature, in order to obtain a permanent magnet containing the 2-17 phase as the main phase, and homogeneously (or uniformly) containing the 2-17 phase and the 1-5 phase, it is preferable to use a method in which the molded body is held at a temperature of 700 to 900° C. for 2 to 20 hours, and after that the cooling rate is set to 2° C./min or lower until the molded body is cooled to 400° C. or lower. By holding the molded body at the temperature of 700° C. to 900° C. for 2 to 20 hours, the 2-17 phase and the 1-5 phase can be homogeneously formed. In particular, the aging treatment is preferably performed in a temperature range of 800 to 850° C. Further, in order to obtain satisfactory magnetic properties, the cooling rate is preferably adjusted to 2° C./min or lower, and more preferably 0.5° C./min or lower.

By using the method for manufacturing a rare-earth cobalt permanent magnet according to this embodiment described above, it is possible to manufacture a rare-earth cobalt permanent magnet having the above-mentioned characteristics. That is, it is possible to manufacture a rare-earth cobalt permanent magnet containing a plurality of crystal grains and grain boundary phases, in which: an average concentration of Mn in the grain boundary phases is 0.5 to 1.5 times higher than an average concentration of Mn in the crystal grains; the crystal grains have a 2-17 phase having a Th₂Zn₁₇-type structure and a 1-5 phase having an RCo₅-type structure; and an average concentration of Mn in the 1-5 phase is 0.4 to 1.5 times higher than an average concentration of Mn in the 2-17 phase.

### <Device>

The embodiment according to the present disclosure can also provide a device including the above-described rare-earth cobalt permanent magnet. Examples of such a device include clocks (watches), electric motors, various instruments, communication apparatuses, computer terminals, speakers, video discs, and sensors. Further, since the magnetic force of the rare-earth cobalt permanent magnet according to this embodiment is less likely to deteriorate even at a high environmental temperature owing to its excellent heat resistance, it can also be suitably used for, for example, an angle sensor or an ignition coil used in an engine compartment of an automobile, or for a drive motor or the like for a hybrid electric vehicle (HEV: Hybrid electric vehicle). In particular, as described above, since the rare-earth cobalt permanent magnet according to this embodiment has a high residual magnetic flux density, a high coercive force, and a high squareness ratio, it can be suitably used for a variable magnetic field motor, thus making it possible to obtain a variable magnetic field motor that achieves high efficiency over a range from a low speed to a high speed.

According to this embodiment described above, it is possible to provide a rare-earth cobalt permanent magnet having excellent magnetic properties, especially an excellent coercive force and excellent squareness, and to provide a method for manufacturing such a rare-earth cobalt permanent magnet and a device.

### EXAMPLES

The present disclosure will be described hereinafter in a concrete manner by using examples and comparative examples. Note that the present disclosure is not limited by the descriptions of examples and the like below.

### Examples 1 to 3

Base alloys each containing 20% of Fe and 80% of Zr, and various raw materials were prepared (i.e., mixed) so that compositions of Examples 1 to 3 shown in Table 1-1 were obtained. Then, they were dissolved by a high-frequency melting furnace, and the molten metals were cast into alloy ingots. The obtained alloy ingots were heat-treated at 1,155° C. (Example 1), 1,180° C. (Example 2), or 1,205° C. (Example 3) for two hours, and then heat-treated at 1,125° C. for five hours. After that, the heat-treated alloy ingots were coarsely pulverized into particles having an average size of about 100 to 500 μm in an inert gas, and then finely pulverized in an inert gas by using a ball mill so that: D10 became about 2.5 μm; D50 became about 6 μm; and D90 became about 13.5 μm. A molded body was obtained by pressing each of these powders at a pressure of 1 ton/cm² in a magnetic field of 15 kOe.

The molded bodies were sintered at 1,205° C. for one hour in a vacuum lower than 1,000 Pa, and then a solution treatment was performed at 1,130° C. for 30 hours. Next, the molded bodies were rapidly cooled from 1,000 to 600° C. at a cooling rate of 80° C./min. After the rapid cooling, the molded bodies were kept at 825° C. for 25 hours, and then were subjected to an aging process under a condition that the molded bodies were slowly cooled to 350° C. at a cooling rate of 0.5° C./min. Through these processes, permanent magnets were obtained. Note that in Table 1-1, ΔT1 is a difference between a sintering temperature (S1) and a first ingot heat treatment temperature (T1), and ΔT2 is a difference between a solution-treatment temperature (S2) and a second ingot heat treatment temperature (T2). Further, S1-S2 is a difference between the sintering temperature (S1) and the solution-treatment temperature (S2). The same applies to other tables.

Magnetic properties of the permanent magnets, which were kept as the molded bodies, were measured. The magnetic properties of the permanent magnets were measured by using a B-H tracer. Further, necessary processes were carried out for the permanent magnets, and the microstructures were observed and the compositions were analyzed by using TEM/EDX. Table 1-2 shows, for each permanent magnet, a residual magnetic flux density (Br), a coercive force (Hcj), a squareness ratio (Hk/Hcj), a ratio of the grain boundary phases having an average concentration of Mn to the crystal grains having the average concentration of Mn, a ratio of the 1-5 phase to the 2-17 phase in the crystal grains (cell structures) having the average concentration of Mn, a ratio of the grain boundary phases having an average concentration of Cu to the crystal grains having the average concentration of Cu, and a ratio of the grain boundary phases having an average concentration of Zr to the crystal grains having the average concentration of Zr.

### Comparative Examples 1 and 2

Permanent magnets according to Comparative Examples 1 and 2 were obtained in the same manner as in Examples 1 to 3 except that the first ingot heat treatment temperature (T1) was changed to those shown for Comparative Examples 1 and 2 in Table 1-1.

TABLE 1-1

| | | First | | | | | | |
|---|---|---|---|---|---|---|---|---|
| | | Ingot Heat | Second | | Solution- | | | |
| | | Treatment | Ingot Heat | Sintering | Treatment | | | |
| | | Temperature | Treatment | Temperature | Temperature | | | |
| | | (T1) | Temperature | (S1) | (S2) | ΔT1 | ΔT2 | S1-S2 |
| | Composition | [° C.] | (T2) [° C.] | [° C.] | [° C.] | [° C.] | [° C.] | [° C.] |
| Example 1 | Sm [symbol] Nd [symbol] Fe [symbol] Cu [symbol] Zr [symbol] Mn [symbol] Co [symbol] | 1155 | 1125 | 1205 | 1130 | 50 | 5 | 75 |
| Example 2 | Sm [symbol] Nd [symbol] Fe [symbol] Cu [symbol] Zr [symbol] Mn [symbol] Co [symbol] | 1180 | 1125 | 1205 | 1130 | 25 | 5 | 75 |
| Example 3 | Sm [symbol] Nd [symbol] Fe [symbol] Cu [symbol] Zr [symbol] Mn [symbol] Co [symbol] | 1205 | 1125 | 1205 | 1130 | 0 | 5 | 75 |
| Comparative | Sm [symbol] Nd [symbol] Fe [symbol] Cu [symbol] Zr [symbol] Mn [symbol] Co [symbol] | 1150 | 1125 | 1205 | 1130 | 55 | 5 | 75 |
| Example 1 | | | | | | | | |
| Comparative | Sm [symbol] Nd [symbol] Fe [symbol] Cu [symbol] Zr [symbol] Mn [symbol] Co [symbol] | 1210 | 1125 | 1205 | 1130 | −5 | 5 | 75 |
| Example 2 | | | | | | | | |

ΔT1 = Sintering Temperature - First Ingor Heat Treatment Temperature
ΔT2 = Solution-Treatment Temperature - Second Ingor Heat Treatment Temperature [symbol]
indicates data missing or illegible when filed

TABLE 1-2

| | Mn Average | Mn Average | Cu Average | Zr Average | | | |
|---|---|---|---|---|---|---|---|
| | Concentration Ratio | Concentration Ratio | Concentration Ratio | Concentration Ratio | | | |
| | (Grain Boundary | (1-5 Phase/2-17 | (Grain Boundary | (Grain Boundary | | | |
| | Phase/Crystal Grain) | Phase) | Phase/Crystal Grain) | Phase/Crystal Grain) | Br [kG] | Hcj [kOe] | Hk/Hcj [%] |
| Example 1 | 0.5 | 0.4 | 3.0 | 6.0 | 12.0 | 20.5 | 65.0 |
| Example 2 | 1.0 | 0.8 | 5.0 | 11.5 | 12.2 | 22.0 | 75.0 |
| Example 3 | 1.5 | 1.2 | 4.0 | 4.5 | 12.1 | 20.0 | 70.0 |
| Comparative | 0.4 | 0.3 | 1.5 | 1.5 | 11.9 | 18.0 | 60.0 |
| Example 1 | | | | | | | |
| Comparative | 1.6 | 1.3 | 1.5 | 1.5 | 11.7 | 19.0 | 60.0 |
| Example 2 | | | | | | | |

As shown in Tables 1-1 and 1-2, in Examples 1 to 3, the average concentration of Mn in the grain boundary phases was 0.5 to 1.5 times the average concentration of Mn in the crystal grains. Further, in Examples 1 to 3, the average concentration of Mn in the Phase 1-5 was 0.4 to 1.2 times the average concentration of Mn in the Phase 2-17. Further, in Examples 1 to 3, the average concentrations of Cu and Zr in the grain boundary phases were at least two times higher than the average concentrations of Cu and Zr in the crystal grains. Therefore, in Examples 1 to 3, the residual magnetic flux density (Br), the coercive force (Hcj), and the squareness ratio (Hk/Hcj) had excellent values.

### Examples 4 to 6

Base alloys each containing 20% of Fe and 80% of Zr, and various raw materials were prepared (i.e., mixed) so that compositions of Examples 4 to 6 shown in Table 2-1 were obtained. Then, they were dissolved by a high-frequency melting furnace, and the molten metals were cast into alloy ingots. The obtained alloy ingots were heat-treated at 1,170° C. for one hour, and then heat-treated at 1,110° C. (Example 4), 1,125° C. (Example 5), or 1,140° C. (Example 6) for five hours. After that, the heat-treated alloy ingots were coarsely pulverized into particles having an average size of about 100 to 500 μm in an inert gas, and then finely pulverized in an inert gas by using a ball mill so that: D10 became about 2.5 μm; D50 became about 6 μm; and D90 became about 13.5 μm. A molded body was obtained by pressing each of these powders at a pressure of 1 ton/cm² in a magnetic field of 15 kOe.

The molded bodies were sintered at 1,200° C. for 1.5 hours in a vacuum lower than 1,000 Pa, and then a solution treatment was performed at 1,140° C. for 100 hours. Next, the molded body was rapidly cooled from 1,000 to 600° C. at a cooling rate of 80° C./min. After the rapid cooling, the molded bodies were kept at 825° C. for 25 hours, and then were subjected to an aging process under a condition that the molded bodies were slowly cooled to 350° C. at a cooling rate of 0.5° C./min. Through these processes, permanent magnets were obtained.

Magnetic properties of the permanent magnets, which were kept as the molded bodies, were measured. The magnetic properties of the permanent magnets were measured by using a B-H tracer. Further, necessary processes were carried out for the permanent magnets, and the microstructures were observed and the compositions were analyzed by using TEM/EDX. Table 2-2 shows, for each permanent magnet, a residual magnetic flux density (Br), a coercive force (Hcj), a squareness ratio (Hk/Hcj), a ratio of the grain boundary phases having an average concentration of Mn to the crystal grains having the average concentration of Mn, a ratio of the 1-5 phase to the 2-17 phase in the crystal grains (cell structures) having the average concentration of Mn, a ratio of the grain boundary phases having an average concentration of Cu to the crystal grains having the average concentration of Cu, and a ratio of the grain boundary phases having an average concentration of Zr to the crystal grains having the average concentration of Zr.

### Comparative Example 3 to 4

Permanent magnets according to Comparative Examples 3 and 4 were obtained in the same manner as in Examples 4 to 6 except that the second ingot heat treatment temperature (T2) was changed to those shown for Comparative Examples 3 and 4 in Table 2-1.

TABLE 2-1

| | | First | Second | | | | | |
|---|---|---|---|---|---|---|---|---|
| | | Ingot Heat | Ingot Heat | | Solution- | | | |
| | | Treatment | Treatment | Sintering | Treatment | | | |
| | | Temperature | Temperature | Temperature | Temperature | | | |
| | | (T1) | (T2) | (S1) | (S2) | ΔT1 | ΔT2 | S1-S2 |
| | Composition | [° C.] | [° C.] | [° C.] | [° C.] | [° C.] | [° C.] | [° C.] |
| Example 4 | Sm_{25.0}Nd_{0.5}Fe_{26.0}Cu_{4.20}Zr_{2.10}Mn_{0.25}Co_{bal} | 1170 | 1110 | 1200 | 1140 | 30 | 30 | 60 |
| Example 5 | Sm_{25.0}Nd_{0.5}Fe_{26.0}Cu_{4.20}Zr_{2.10}Mn_{0.25}Co_{bal} | 1170 | 1125 | 1200 | 1140 | 30 | 15 | 60 |
| Example 6 | Sm_{25.0}Nd_{0.5}Fe_{26.0}Cu_{4.20}Zr_{2.10}Mn_{0.25}Co_{bal} | 1170 | 1140 | 1200 | 1140 | 30 | 0 | 60 |
| Comparative | Sm_{25.0}Nd_{0.5}Fe_{26.0}Cu_{4.20}Zr_{2.10}Mn_{0.25}Co_{bal} | 1170 | 1105 | 1200 | 1140 | 30 | 35 | 60 |
| Example 3 | | | | | | | | |
| Comparative | Sm_{25.0}Nd_{0.5}Fe_{26.0}Cu_{4.20}Zr_{2.10}Mn_{0.25}Co_{bal} | 1170 | 1145 | 1200 | 1140 | 30 | −5 | 60 |
| Example 4 | | | | | | | | |

ΔT1 = Sintering Temperature - First Ingor Heat Treatment Temperature
ΔT2 = Solution-Treatment Temperature - Second Ingor Heat Treatment Temperature

TABLE 2-2

| | Mn Average | Mn Average | Cu Average | Zr Average | | | |
|---|---|---|---|---|---|---|---|
| | Concentration Ratio | Concentration Ratio | Concentration Ratio | Concentration Ratio | | | |
| | (Grain Boundary | (1-5 Phase/2-17 | (Grain Boundary | (Grain Boundary | | | |
| | Phase/Crystal Grain) | Phase) | Phase/Crystal Grain) | Phase/Crystal Grain) | Br [kG] | Hcj [kOe] | Hk/Hcj [%] |
| Example 4 | 0.6 | 0.6 | 2.2 | 5.0 | 12.2 | 20.7 | 65.0 |
| Example 5 | 0.9 | 0.8 | 4.5 | 8.0 | 12.3 | 21.1 | 70.5 |
| Example 6 | 0.5 | 0.7 | 3.3 | 2.7 | 12.0 | 20.1 | 66.6 |
| Comparative | 0.3 | 0.2 | 1.2 | 1.7 | 11.7 | 19.9 | 55.0 |
| Example 3 | | | | | | | |
| Comparative | 0.4 | 0.3 | 1.5 | 1.9 | 11.8 | 17.5 | 62.0 |
| Example 4 | | | | | | | |

As shown in Tables 2-1 and 2-2, in Examples 4 to 6, the average concentration of Mn in the grain boundary phases was 0.5 to 0.9 times the average concentration of Mn in the crystal grains. Further, in Examples 4 to 6, the average concentration of Mn in the Phase 1-5 was 0.6 to 0.8 times the average concentration of Mn in the Phase 2-17. Further, in Examples 4 to 6, the average concentrations of Cu and Zr in the grain boundary phases were at least two times higher than the average concentrations of Cu and Zr in the crystal grains. Therefore, in Examples 4 to 6, the residual magnetic flux density (Br), the coercive force (Hcj), and the squareness ratio (Hk/Hcj) had excellent values.

### Example 7 to 12

Base alloys each containing 20% of Fe and 80% of Zr, and various raw materials were prepared (i.e., mixed) so that compositions of Examples 7 to 12 shown in Table 3-1 were obtained. Then, they were dissolved by a high-frequency melting furnace, and the molten metals were cast into alloy ingots. In Example 7, the obtained alloy ingot was heat-treated at 1,170° C. for one hour, and then heat-treated at 1,135° C. for six hours. In Example 8, the obtained alloy ingot was heat-treated at 1,170° C. for one hour, and then heat-treated at 1,130° C. for six hours. In Example 9, the obtained alloy ingot was heat-treated at 1,185° C. for one hour, and then heat-treated at 1,135° C. for six hours. In Example 10, the obtained alloy ingot was heat-treated at 1185° C. for one hour, and then heat-treated at 1130° C. for six hours. In Example 11, the obtained alloy ingot was heat-treated at 1210° C. for one hour, and then heat-treated at 1135° C. for six hours. In Example 12, the obtained alloy ingot was heat-treated at 1210° C. for one hour, and then heat-treated at 1130° C. for six hours.

After that, the heat-treated alloy ingots were coarsely pulverized into particles having an average size of about 100 to 500 μm in an inert gas, and then finely pulverized in an inert gas by using a ball mill so that: D10 became about 2.5 μm; D50 became about 6 μm; and D90 became about 13.5 μm. A molded body was obtained by pressing each of these powders at a pressure of 1 ton/cm² in a magnetic field of 15 kOe.

In Examples 7, 9 and 11, the molded bodies were sintered at 1,210° C. for 0.5 hours in a vacuum lower than 1,000 Pa, and then a solution treatment was performed at 1,165° C. for 50 hours. In Examples 8, 10 and 12, the molded bodies were sintered at 1,210° C. for 0.5 hours in a vacuum lower than 1,000 Pa, and then a solution treatment was performed at 1,160° C. for 50 hours. Next, the molded body was rapidly cooled from 1,000 to 600° C. at a cooling rate of 80° C./min. After the rapid cooling, the molded bodies were kept at 825° C. for 25 hours, and then were subjected to an aging process under a condition that the molded bodies were slowly cooled to 350° C. at a cooling rate of 0.5° C./min. Through these processes, permanent magnets were obtained.

Magnetic properties of the permanent magnets, which were kept as the molded bodies, were measured. The magnetic properties of the permanent magnets were measured by using a B-H tracer. Further, necessary processes were carried out for the permanent magnets, and the microstructures were observed and the compositions were analyzed by using TEM/EDX. Table 3-2 shows, for each permanent magnet, a residual magnetic flux density (Br), a coercive force (Hcj), a squareness ratio (Hk/Hcj), a ratio of the grain boundary phases having an average concentration of Mn to the crystal grains having the average concentration of Mn, a ratio of the 1-5 phase to the 2-17 phase in the crystal grains (cell structures) having the average concentration of Mn, a ratio of the grain boundary phases having an average concentration of Cu to the crystal grains having the average concentration of Cu, and a ratio of the grain boundary phases having an average concentration of Zr to the crystal grains having the average concentration of Zr.

### Comparative Examples 5 to 8

Permanent magnets according to Comparative Examples 5 to 8 were obtained in the same manner as in Examples 7 to 12 except that the conditions for the heat treatment, sintering, and solution treatment of the alloy ingots were changed as follows.

In Comparative Example 5, the obtained alloy ingot was heat-treated at 1,160° C. for one hour, and then heat-treated at 1,135° C. for six hours. In Comparative Example 6, the obtained alloy ingot was heat-treated at 1,160° C. for one hour, and then heat-treated at 1,130° C. for six hours. In Comparative Example 7, the obtained alloy ingot was heat-treated at 1,215° C. for one hour, and then heat-treated at 1,135° C. for six hours. In Comparative Example 8, the obtained alloy ingot was heat-treated at 1,215° C. for one hour, and then heat-treated at 1,130° C. for six hours.

Further, in Comparative Examples 5 and 7, the molded bodies were sintered at 1,210° C. for one hour in a vacuum lower than 1,000 Pa, and then a solution treatment was performed at 1,165° C. for six hours. In Comparative Examples 6 and 8, the molded bodies were sintered at 1,210° C. for one hour in a vacuum lower than 1,000 Pa, and then a solution treatment was performed at 1,160° C. for six hours.

TABLE 3-1

| | | First | Second | | | | | |
|---|---|---|---|---|---|---|---|---|
| | | Ingot Heat | Ingot Heat | | Solution- | | | |
| | | Treatment | Treatment | Sintering | Treatment | | | |
| | | Temperature | Temperature | Temperature | Temperature | | | |
| | | (T1) | (T2) | (S1) | (S2) | ΔT1 | ΔT2 PC] | S1-S2 |
| | Composition | [° C.] | [° C.] | [° C.] | [° C.] | [° C.] | [° C.] | [° C.] |
| Example 7 | Sm [symbol] Nd [symbol] Fe [symbol] Cu [symbol] Zr [symbol] Mn [symbol] Co [symbol] | 1170 | 1135 | 1210 | 1165 | 40 | 30 | 45 |
| Example 8 | Sm [symbol] Nd [symbol] Fe [symbol] Cu [symbol] Zr [symbol] Mn [symbol] Co [symbol] | 1170 | 1130 | 1210 | 1160 | 40 | 30 | 50 |
| Example 9 | Sm [symbol] Nd [symbol] Fe [symbol] Cu [symbol] Zr [symbol] Mn [symbol] Co [symbol] | 1185 | 1135 | 1210 | 1165 | 25 | 30 | 45 |
| Example 10 | Sm [symbol] Nd [symbol] Fe [symbol] Cu [symbol] Zr [symbol] Mn [symbol] Co [symbol] | 1185 | 1130 | 1210 | 1160 | 25 | 30 | 50 |
| Example 11 | Sm [symbol] Nd [symbol] Fe [symbol] Cu [symbol] Zr [symbol] Mn [symbol] Co [symbol] | 1210 | 1135 | 1210 | 1165 | 0 | 30 | 45 |
| Example 12 | Sm [symbol] Nd [symbol] Fe [symbol] Cu [symbol] Zr [symbol] Mn [symbol] Co [symbol] | 1210 | 1130 | 1210 | 1160 | 0 | 30 | 50 |
| Comparative | Sm [symbol] Nd [symbol] Fe [symbol] Cu [symbol] Zr [symbol] Mn [symbol] Co [symbol] | 1160 | 1135 | 1210 | 1165 | 50 | 30 | 45 |
| Example 5 | | | | | | | | |
| Comparative | Sm [symbol] Nd [symbol] Fe [symbol] Cu [symbol] Zr [symbol] Mn [symbol] Co [symbol] | 1160 | 1130 | 1210 | 1160 | 50 | 30 | 50 |
| Example 6 | | | | | | | | |
| Comparative | Sm [symbol] Nd [symbol] Fe [symbol] Cu [symbol] Zr [symbol] Mn [symbol] Co [symbol] | 1215 | 1135 | 1210 | 1165 | −5 | 30 | 45 |
| Example 7 | | | | | | | | |
| Comparative | Sm [symbol] Nd [symbol] Fe [symbol] Cu [symbol] Zr [symbol] Mn [symbol] Co [symbol] | 1215 | 1130 | 1210 | 1160 | −5 | 30 | 50 |
| Example 8 | | | | | | | | |

ΔT1 = Sintering Temperature - First Ingor Heat Treatment Temperature
ΔT2 = Solution-Treatment Temperature - Second Ingor Heat Treatment Temperature [symbol]
indicates data missing or illegible when filed

TABLE 3-2

| | Mn Average | Mn Average | Cu Average | Zr Average | | | |
|---|---|---|---|---|---|---|---|
| | Concentration Ratio | Concentration Ratio | Concentration Ratio | Concentration Ratio | | | |
| | (Grain Boundary | (1-5 Phase/2-17 | (Grain Boundary | (Grain Boundary | | | |
| | Phase/Crystal Grain) | Phase) | Phase/Crystal Grain) | Phase/Crystal Grain) | Br [kG] | Hcj [kOe] | Hk/Hcj [%] |
| Example 7 | 0.7 | 0.5 | 4.3 | 4.6 | 12.2 | 21.5 | 65.5 |
| Example 8 | 0.5 | 0.5 | 3.5 | 2.8 | 11.9 | 20.3 | 65.7 |
| Example 9 | 0.8 | 0.8 | 6.6 | 10.8 | 12.3 | 22.2 | 73.7 |
| Example 10 | 0.6 | 0.4 | 3.3 | 2.9 | 12.0 | 20.4 | 66.1 |
| Example 11 | 0.6 | 0.6 | 5.5 | 6.4 | 12.0 | 23.1 | 69.4 |
| Example 12 | 0.5 | 0.4 | 3.2 | 2.5 | 12.0 | 20.1 | 65.1 |
| Comparative | 1.9 | 0.3 | 1.9 | 1.9 | 11.7 | 19.7 | 63.4 |
| Example 5 | | | | | | | |
| Comparative | 1.8 | 0.4 | 1.8 | 1.8 | 11.8 | 18.2 | 61.5 |
| Example 6 | | | | | | | |
| Comparative | 1.7 | 1.2 | 1.9 | 1.8 | 11.7 | 17.7 | 59.4 |
| Example 7 | | | | | | | |
| Comparative | 1.8 | 1.0 | 1.8 | 1.9 | 11.8 | 16.5 | 58.6 |
| Example 8 | | | | | | | |

As shown in Tables 3-1 and 3-2, in Examples 7 to 12, the average concentration of Mn in the grain boundary phases was 0.5 to 0.8 times the average concentration of Mn in the crystal grains. Further, in Examples 7 to 12, the average concentration of Mn in the Phase 1-5 was 0.4 to 0.8 times the average concentration of Mn in the Phase 2-17. Further, in Examples 7 to 12, the average concentrations of Cu and Zr in the grain boundary phases were at least two times higher than the average concentrations of Cu and Zr in the crystal grains. Therefore, in Examples 7 to 12, the residual magnetic flux density (Br), the coercive force (Hcj), and the squareness ratio (Hk/Hcj) had excellent values.

### Example 13 to 20

Base alloys each containing 20% of Fe and 80% of Zr, and various raw materials were prepared (i.e., mixed) so that compositions of Examples 13 to 20 shown in Table 4-1 were obtained. Then, they were dissolved by a high-frequency melting furnace, and the molten metals were cast into alloy ingots. In Example 13, the obtained alloy ingot was heat-treated at 1,185° C. for one hour, and then heat-treated at 1,130° C. for six hours. In Example 14, the obtained alloy ingot was heat-treated at 1,160° C. for one hour, and then heat-treated at 1,100° C. for 10 hours. In Examples 15 and 16, the obtained alloy ingots were heat-treated at 1,180° C. for two hours, and then heat-treated at 1,120° C. for eight hours. In Examples 17 and 18, the obtained alloy ingots were heat-treated at 1,175° C. for three hours, and then heat-treated at 1,125° C. for four hours. In Examples 19 and 20, the obtained alloy ingots were heat-treated at 1,195° C. for 1.5 hours, and then heat-treated at 1,115° C. for nine hours.

After that, the heat-treated alloy ingots were coarsely pulverized into particles having an average size of about 100 to 500 μm in an inert gas, and then finely pulverized in an inert gas by using a ball mill so that: D10 became about 2.5 μm; D50 became about 6 μm; and D90 became about 13.5 μm. A molded body was obtained by pressing each of these powders at a pressure of 1 ton/cm² in a magnetic field of 15 kOe.

In Example 13, the molded body was sintered at 1,215° C. for 1.5 hours in a vacuum lower than 1,000 Pa, and then a solution treatment was performed at 1,140° C. for 30 hours. In Example 14, the molded body was sintered at 1,170° C. for 2.5 hours in a vacuum lower than 1,000 Pa, and then a solution treatment was performed at 1,110° C. for 40 hours. In Examples 15 and 16, the molded bodies were sintered at 1,185° C. for 2.0 hours in a vacuum lower than 1,000 Pa, and then a solution treatment was performed at 1,125° C. for 50 hours. In Examples 17 and 18, the molded bodies were sintered at 1,195° C. for 1.0 hours in a vacuum lower than 1,000 Pa, and then a solution treatment was performed at 1,140° C. for 60 hours. In Examples 19 and 20, the molded bodies were sintered at 1,200° C. for 1.0 hours in a vacuum lower than 1,000 Pa, and then a solution treatment was performed at 1,130° C. for 50 hours.

Next, the molded body was rapidly cooled from 1,000 to 600° C. at a cooling rate of 80° C./min. After the rapid cooling, the molded bodies were kept at 825° C. for 25 hours, and then were subjected to an aging process under a condition that the molded bodies were slowly cooled to 350° C. at a cooling rate of 0.5° C./min. Through these processes, permanent magnets were obtained.

Magnetic properties of the permanent magnets, which were kept as the molded bodies, were measured. The magnetic properties of the permanent magnets were measured by using a B-H tracer. Further, necessary processes were carried out for the permanent magnets, and the microstructures were observed and the compositions were analyzed by using TEM/EDX. Table 4-2 shows, for each permanent magnet, a residual magnetic flux density (Br), a coercive force (Hcj), a squareness ratio (Hk/Hcj), a ratio of the grain boundary phases having an average concentration of Mn to the crystal grains having the average concentration of Mn, a ratio of the 1-5 phase to the 2-17 phase in the crystal grains (cell structures) having the average concentration of Mn, a ratio of the grain boundary phases having an average concentration of Cu to the crystal grains having the average concentration of Cu, and a ratio of the grain boundary phases having an average concentration of Zr to the crystal grains having the average concentration of Zr.

### Comparative Examples 9 to 18

Base alloys each containing 20% of Fe and 80% of Zr, and various raw materials were prepared (i.e., mixed) so that compositions of Examples 9 to 18 shown in Table 4-1 were obtained. Then, they were dissolved by a high-frequency melting furnace, and the molten metals were cast into alloy ingots. In Comparative Examples 9 and 10, the obtained alloy ingots were heat-treated at 1,185° C. for one hour, and then heat-treated at 1,130° C. for six hours. In Comparative Examples 11 and 12, the obtained alloy ingots were heat-treated at 1,160° C. for one hour, and then heat-treated at 1,100° C. for 10 hours. In Comparative Examples 13 and 14, the obtained alloy ingots were heat-treated at 1,180° C. for two hours, and then heat-treated at 1,120° C. for eight hours. In Comparative Examples 15 and 16, the obtained alloy ingots were heat-treated at 1,175° C. for three hours, and then heat-treated at 1,125° C. for four hours. In Comparative Examples 17 and 18, the obtained alloy ingots were heat-treated at 1,195° C. for 1.5 hours, and then heat-treated at 1,115° C. for nine hours.

After that, the heat-treated alloy ingots were coarsely pulverized into particles having an average size of about 100 to 500 μm in an inert gas, and then finely pulverized in an inert gas by using a ball mill so that: D10 became about 2.5 μm; D50 became about 6 μm; and D90 became about 13.5 μm. A molded body was obtained by pressing each of these powders at a pressure of 1 ton/cm² in a magnetic field of 15 kOe.

In Comparative Examples 9 and 10, the molded bodies were sintered at 1,215° C. for 1.5 hours in a vacuum lower than 1,000 Pa, and then a solution treatment was performed at 1,140° C. for 30 hours. In Comparative Examples 11 and 12, the molded bodies were sintered at 1,170° C. for 2.5 hours in a vacuum lower than 1,000 Pa, and then a solution treatment was performed at 1,110° C. for 40 hours. In Comparative Examples 13 and 14, the molded bodies were sintered at 1,185° C. for 2.0 hours in a vacuum lower than 1,000 Pa, and then a solution treatment was performed at 1,125° C. for 50 hours. In Comparative Examples 15 and 16, the molded bodies were sintered at 1,195° C. for 1.0 hours in a vacuum lower than 1,000 Pa, and then a solution treatment was performed at 1,140° C. for 60 hours. In Comparative Examples 17 and 18, the molded bodies were sintered at 1,200° C. for 1.0 hours in a vacuum lower than 1,000 Pa, and then a solution treatment was performed at 1,130° C. for 50 hours.

Next, the molded body was rapidly cooled from 1,000 to 600° C. at a cooling rate of 80° C./min. After the rapid cooling, the molded bodies were kept at 825° C. for 25 hours, and then were subjected to an aging process under a condition that the molded bodies were slowly cooled to 350° C. at a cooling rate of 0.5° C./min. Through these processes, permanent magnets were obtained.

Magnetic properties of the permanent magnets, which were kept as the molded bodies, were measured. The magnetic properties of the permanent magnets were measured by using a B-H tracer. Further, necessary processes were carried out for the permanent magnets, and the microstructures were observed and the compositions were analyzed by using TEM/EDX. Table 3-2 shows, for each permanent magnet, a residual magnetic flux density (Br), a coercive force (Hcj), a squareness ratio (Hk/Hcj), a ratio of the grain boundary phases having an average concentration of Mn to the crystal grains having the average concentration of Mn, a ratio of the 1-5 phase to the 2-17 phase in the crystal grains (cell structures) having the average concentration of Mn, a ratio of the grain boundary phases having an average concentration of Cu to the crystal grains having the average concentration of Cu, and a ratio of the grain boundary phases having an average concentration of Zr to the crystal grains having the average concentration of Zr.

TABLE 4-1

| | | First | Second | | | | | |
|---|---|---|---|---|---|---|---|---|
| | | Ingot Heat | Ingot Heat | | Solution- | | | |
| | | Treatment | Treatment | Sintering | Treatment | | | |
| | | Temperature | Temperature | Temperature | Temperature | | | |
| | | (T1) | (T2) | (S1) | (S2) | ΔT1 | ΔT2 | S1-S2 |
| | Composition | [° C.] | [° C.] | [° C.] | [° C.] | [° C.] | [° C.] | [° C.] |
| Example 13 | Sm [symbol] Fe [symbol] Cu [symbol] Zr [symbol] Mn [symbol] Co [symbol] | 1185 | 1130 | 1215 | 1140 | 30 | 10 | 75 |
| Comparative | Sm [symbol] Fe [symbol] Cu [symbol] Zr [symbol] Mn [symbol] Co [symbol] | 1185 | 1130 | 1215 | 1140 | 30 | 10 | 75 |
| Example 9 | | | | | | | | |
| Comparative | Sm [symbol] Fe [symbol] Cu [symbol] Zr [symbol] Mn [symbol] Co [symbol] | 1185 | 1130 | 1215 | 1140 | 30 | 10 | 75 |
| Example 10 | | | | | | | | |
| Example 14 | Sm [symbol] Fe [symbol] Cu [symbol] Zr [symbol] Mn [symbol] Co [symbol] | 1160 | 1100 | 1170 | 1110 | 10 | 10 | 60 |
| Comparative | Sm [symbol] Fe [symbol] Cu [symbol] Zr [symbol] Mn [symbol] Co [symbol] | 1160 | 1100 | 1170 | 1110 | 10 | 10 | 60 |
| Example 11 | | | | | | | | |
| Comparative | Sm [symbol] Fe [symbol] Cu [symbol] Zr [symbol] Mn [symbol] Co [symbol] | 1160 | 1100 | 1170 | 1110 | 10 | 10 | 60 |
| Example 12 | | | | | | | | |
| Example 15 | Sm [symbol] Fe [symbol] Cu [symbol] Zr [symbol] Mn [symbol] Co [symbol] | 1180 | 1120 | 1185 | 1125 | 5 | 5 | 60 |
| Example 16 | Sm [symbol] Fe [symbol] Cu [symbol] Zr [symbol] Mn [symbol] Co [symbol] | 1180 | 1120 | 1185 | 1125 | 5 | 5 | 60 |
| Comparative | Sm [symbol] Fe [symbol] Cu [symbol] Zr [symbol] Mn [symbol] Co [symbol] | 1180 | 1120 | 1185 | 1125 | 5 | 5 | 60 |
| Example 13 | | | | | | | | |
| Comparative | Sm [symbol] Fe [symbol] Cu [symbol] Zr [symbol] Mn [symbol] Co [symbol] | 1180 | 1120 | 1185 | 1125 | 5 | 5 | 60 |
| Example 14 | | | | | | | | |
| Example 17 | Sm [symbol] Nd [symbol] Fe [symbol] Cu [symbol] Zr [symbol] Mn [symbol] Co [symbol] | 1175 | 1125 | 1195 | 1140 | 20 | 15 | 55 |
| Example 18 | Sm [symbol] Nd [symbol] Fe [symbol] Cu [symbol] Zr [symbol] Mn [symbol] Co [symbol] | 1175 | 1125 | 1195 | 1140 | 20 | 15 | 55 |
| Comparative | Sm [symbol] Nd [symbol] Fe [symbol] Cu [symbol] Zr [symbol] Mn [symbol] Co [symbol] | 1175 | 1125 | 1195 | 1140 | 20 | 15 | 55 |
| Example 15 | | | | | | | | |
| Comparative | Sm [symbol] Nd [symbol] Fe [symbol] Cu [symbol] Zr [symbol] Mn [symbol] Co [symbol] | 1175 | 1125 | 1195 | 1140 | 20 | 15 | 55 |
| Example 16 | | | | | | | | |
| Example 19 | Sm [symbol] Nd [symbol] Fe [symbol] Cu [symbol] Zr [symbol] Mn [symbol] Co [symbol] | 1195 | 1115 | 1200 | 1130 | 5 | 15 | 70 |
| Example 20 | Sm [symbol] Nd [symbol] Fe [symbol] Cu [symbol] Zr [symbol] Mn [symbol] Co [symbol] | 1195 | 1115 | 1200 | 1130 | 5 | 15 | 70 |
| Comparative | Sm [symbol] Nd [symbol] Fe [symbol] Cu [symbol] Zr [symbol] Mn [symbol] Co [symbol] | 1195 | 1115 | 1200 | 1130 | 5 | 15 | 70 |
| Example 17 | | | | | | | | |
| Comparative | Sm [symbol] Nd [symbol] Fe [symbol] Cu [symbol] Zr [symbol] Mn [symbol] Co [symbol] | 1195 | 1115 | 1200 | 1130 | 5 | 15 | 70 |
| Example 18 | | | | | | | | |

[symbol]

indicates data missing or illegible when filed

TABLE 4-2

| | Mn Average | Mn Average | Cu Average | Zr Average | | | |
|---|---|---|---|---|---|---|---|
| | Concentration Ratio | Concentration Ratio | Concentration Ratio | Concentration Ratio | | | |
| | (Grain Boundary | (1-5 Phase/2-17 | (Grain Boundary | (Grain Boundary | | | |
| | Phase/Crystal Grain) | Phase) | Phase/Crystal Grain) | Phase/Crystal Grain) | Br [kG] | Hcj [kOe] | Hk/Hcj [%] |
| Example 13 | 0.7 | 0.5 | 3.8 | 4.2 | 11.9 | 22.7 | 66.1 |
| Comparative | 0.3 | 1.3 | 1.8 | 1.7 | 11.9 | 19.7 | 62.9 |
| Example 9 | | | | | | | |
| Comparative | 0.2 | 0.3 | 1.7 | 1.9 | 11.7 | 17.4 | 63.6 |
| Example 10 | | | | | | | |
| Example 14 | 0.5 | 0.5 | 4.1 | 4.2 | 12.1 | 20.9 | 65.5 |
| Comparative | 0.4 | 1.4 | 1.9 | 1.8 | 12.0 | 18.6 | 62.5 |
| Example 11 | | | | | | | |
| Comparative | 1.6 | 0.3 | 1.5 | 1.9 | 11.7 | 19.2 | 62.8 |
| Example 12 | | | | | | | |
| Example 15 | 1.0 | 0.9 | 2.4 | 5.1 | 12.2 | 21.5 | 71.9 |
| Example 16 | 0.6 | 0.7 | 6.6 | 4.7 | 12.1 | 24.3 | 67.3 |
| Comparative | 1.6 | 1.4 | 1.6 | 1.9 | 12.0 | 19.7 | 63.0 |
| Example 13 | | | | | | | |
| Comparative | 0.4 | 0.2 | 2.5 | 1.7 | 11.7 | 25.0 | 58.5 |
| Example 14 | | | | | | | |
| Example 17 | 0.8 | 0.8 | 5.1 | 4.9 | 12.3 | 22.8 | 72.3 |
| Example 18 | 1.1 | 0.9 | 5.1 | 7.5 | 12.0 | 21.6 | 73.8 |
| Comparative | 0.4 | 0.2 | 1.7 | 1.6 | 11.8 | 22.4 | 57.7 |
| Example 15 | | | | | | | |
| Comparative | 1.7 | 1.6 | 1.8 | 3.1 | 11.7 | 19.9 | 61.8 |
| Example 16 | | | | | | | |
| Example 19 | 0.5 | 0.4 | 4.5 | 3.6 | 12.3 | 23.1 | 70.5 |
| Example 20 | 1.5 | 1.2 | 3.5 | 5.4 | 11.8 | 20.0 | 68.7 |
| Comparative | 0.2 | 0.2 | 1.9 | 1.5 | 12.0 | 24.0 | 59.9 |
| Example 17 | | | | | | | |
| Comparative | 1.8 | 1.4 | 1.8 | 1.8 | 11.6 | 18.1 | 61.6 |
| Example 18 | | | | | | | |

As shown in Tables 4-1 and 4-2, the composition of Sm, which is a rare-earth element, was changed in Example 13 and Comparative Examples 9 and 10. Based on the results of Example 13 and Comparative Examples 9 and 10, when the composition range of Sm is 24 to 27 wt %, the residual magnetic flux density (Br), the coercive force (Hcj), and the squareness ratio (Hk/Hcj) had excellent values. In Example 14 and Comparative Examples 11 and 12, the composition of Fe was changed. Based on the results of Example 14 and Comparative Examples 11 and 12, when the composition range of Fe is 23 to 27 wt %, the residual magnetic flux density (Br), the coercive force (Hcj), and the squareness ratio (Hk/Hcj) had excellent values. In Examples 15 and 16 and Comparative Examples 13 and 14, the composition of Cu was changed. Based on the results of Examples 15 and 16 and Comparative Examples 13 and 14, when the composition of Cu is 4.0 to 5.0 wt %, the residual magnetic flux density (Br), the coercive force (Hcj), and the squareness ratio (Hk/Hcj) had excellent values.

In Examples 17 and 18 and Comparative Examples 15 and 16, the composition of Zr was changed. Based on the results of Examples 17 and 18 and Comparative Examples 15 and 16, when the composition range of Zr is 1.5 to 2.5 wt %, the residual magnetic flux density (Br), the coercive force (Hcj), and the squareness ratio (Hk/Hcj) had excellent values. In Examples 19 and 20 and Comparative Examples 17 and 18, the composition of Mn was changed. Based on the results of Examples 19 and 20 and Comparative Examples 17 and 18, when the composition range of Mn is 0.1 to 2.5 wt %, the residual magnetic flux density (Br), the coercive force (Hcj), and the squareness ratio (Hk/Hcj) had excellent values.

As shown in the above-described Examples 1 to 20, when a sample was manufactured under predetermined conditions, the average concentration of Mn in the grain boundary phases was in a range of 0.5 and 1.5 times the average concentration of Mn in the crystal grains (Condition A). Further, the average concentration of Mn in the Phase 1-5 was 0.4 and 1.5 times the average concentration of Mn in the Phase 2-17 (Condition B). Further, the average concentrations of Cu and Zr in the grain boundary phases were at least two times higher than the average concentrations of Cu and Zr in the crystal grains (Condition C). Further, the residual magnetic flux density (Br) was 11.8 kG or higher; the coercive force (Hcj) was 20 kOe; and the squareness ratio (Hk/Hcj) was 65% or higher.

On the other hand, at least one or all of the above-described Conditions A to C were not satisfied in samples in which the heat treatment condition of the ingot was out of the predetermined range or the composition was out of the predetermined range (i.e., in Comparative Examples 1 to 18). Further, in Comparative Examples 1 to 18, at least one or all of the conditions that: the residual magnetic flux density (Br) is 11.8 kG or higher; the coercive force (Hcj) was 20 kOe; and the squareness ratio (Hk/Hcj) was 65% or higher, were also not satisfied.

From the disclosure thus described, embodiments of the disclosure may be varied in many ways. Such variations are not to be regarded as a departure from the spirit and scope of the disclosure, and all such modifications as readily understood to one skilled in the art are intended for inclusion within the scope of the following claims.

What is claimed is:

1. A rare-earth cobalt permanent magnet consisting of a sintered compact having a composition consisting of R: 24 to 27 wt % (R is a sum total of rare-earth elements including at least Sm), Fe: 23 to 27 wt %, Cu: 4.0 to 5.0 wt %, Zr: 1.5 to 2.5 wt %, Mn: 0.1 to 2.5 wt %, and a remainder consisting of Co and unavoidable impurities, wherein
the rare-earth cobalt permanent magnet contains a plurality of crystal grains and grain boundary phases, and an average concentration of Mn in the grain boundary phases is 0.5 to 1.5 times higher than an average concentration of Mn in the crystal grains, and
the crystal grains have a 2-17 phase having a Th₂Zn₁₇-type structure and a 1-5 phase having an RCo₅-type structure, and an average concentration of Mn in the 1-5 phase is 0.4 to 1.5 times higher than an average concentration of Mn in the 2-17 phase.

2. The rare-earth cobalt permanent magnet according to claim 1, wherein average concentrations of Cu and Zr in the grain boundary phases are at least two times higher than average concentrations of Cu and Zr in the crystal grains.

3. The rare-earth cobalt permanent magnet according to claim 1, wherein the average concentration of Mn in the grain boundary phases is 0.8 to 1.2 times higher than the average concentration of Mn in the crystal grains.

4. The rare-earth cobalt permanent magnet according to claim 1, wherein the average concentration of Mn in the 1-5 phase is 0.8 to 1.0 times higher than the average concentration of Mn in the 2-17 phase.

5. The rare-earth cobalt permanent magnet according to claim 1, wherein average concentrations of Cu and Zr in the grain boundary phases are at least four times higher than average concentrations of Cu and Zr in the crystal grains.

6. The rare-earth cobalt permanent magnet according to claim 1, wherein a residual magnetic flux density (Br) is 11.8 kG or higher.

7. The rare-earth cobalt permanent magnet according to claim 1, wherein a coercive force (Hcj) is 20 kOe or higher.

8. The rare-earth cobalt permanent magnet according to claim 1, wherein a squareness ratio expressed as a ratio (Hk/Hcj) of a magnetic field (Hk) to a coercive force (Hcj) is 65% or higher.

9. A device comprising the rare-earth cobalt permanent magnet according to claim 1.

10. A method for manufacturing a rare-earth cobalt permanent magnet comprising:
a step (I) of preparing an ingot containing raw materials so that, after sintering, the ingot has a composition consisting of R: 24 to 27 wt % (R is a sum total of rare-earth elements including at least Sm), Fe: 23 to 27 wt %, Cu: 4.0 to 5.0 wt %, Zr: 1.5 to 2.5 wt %, Mn: 0.1 to 2.5 wt %, and a remainder consisting of Co and unavoidable impurities;
a pulverizing step (II) of pulverizing the ingot into a powder;
a pressure-molding step (III) of molding the powder into a molded body;
a sintering step (IV) of heating the molded body and thereby forming a sintered compact;
a solution-treatment step (V) of heating the sintered compact and thereby performing a solution treatment; and
a rapid cooling step (VI) of rapidly cooling the sintered compact after the solution-treatment step (V), and
an aging process step (VII) of forming a 2-17 phase having a Th₂Zn₁₇-type structure and a 1-5 phase having an RCo₅-type structure, wherein
the step (I) of preparing the ingot comprises:
a first ingot heat treatment step of treating mixture of the raw materials at a first ingot heat treatment temperature; and
a second ingot heat treatment step of treating the mixture at a second ingot heat treatment temperature after the first ingot heat treatment step, and
when a sintering temperature of the molded body is represented by S1 and a temperature of the solution treatment is represented by S2,
the first ingot heat treatment temperature T1 satisfies a relation S1−50≤T1≤S1 (however, when a temperature difference between S1 and S2 is equal to or smaller than 50° C., the first ingot heat treatment temperature T1 satisfies a relation S2<T1≤S1), and
the second ingot heat treatment temperature T2 satisfies a relation S2−30≤T2≤S2.

11. The method for manufacturing the rare-earth cobalt permanent magnet according to claim 10, wherein
a heat treatment time of the first ingot heat treatment step is not shorter than 0.5 hours and not longer than 3.0 hours, and
a second heat treatment time of the second ingot heat treatment step is not shorter than 1.0 hours and not longer than 10.0 hours.

12. The method for manufacturing the rare-earth cobalt permanent magnet according to claim 10, wherein
the sintering step (IV) is a step of heating the molded body at a temperature that is not lower than 1,170° C. and not higher than 1,215° C. for a time period that is not shorter than 20 minutes and not longer than 210 minutes,
the solution-treatment step (V) is a step of heating the sintered compact at a temperature that is not lower than 1,110° C. and not higher than 1,165° C. for a time period that is not shorter than five hours and not longer than 150 hours, and
the rapid cooling step (VI) is a step of, after the solution-treatment step (V), cooling the sintered compact at least for a period from the solution-treatment temperature to 600° C. at a cooling rate of 60° C./min or higher.

13. The method for manufacturing the rare-earth cobalt permanent magnet according to claim 10, wherein in the pulverizing step (II), the ingot is pulverized so that: a particle size D10 becomes smaller than 4 μm; a particle size D50 becomes no smaller than 5 μm and no larger than 8 μm; and a particle size D90 becomes smaller than 16 μm.

14. The method for manufacturing the rare-earth cobalt permanent magnet according to claim 10, wherein
the rare-earth cobalt permanent magnet contains a plurality of crystal grains and grain boundary phases, and an average concentration of Mn in the grain boundary phases is 0.5 to 1.5 times higher than an average concentration of Mn in the crystal grains, and
the crystal grains have the 2-17 phase having the Th₂Zn₁₇-type structure and the 1-5 phase having the RCo₅-type structure, and an average concentration of Mn in the 1-5 phase is 0.4 to 1.5 times higher than an average concentration of Mn in the 2-17 phase.
